(19) United States
(12) Patent Application Publication
(10) Pub. No.: US 2002/0148838 A1
(43) Pub. Date: Oct. 17, 2002

(54) BOTTOM STRUCTURE OF A KETTLE

(76) Inventor: Jae Jung Sim, Inchon-Shi (KR)

Correspondence Address: STAAS & HALSEY LLP, 700 11TH STREET, NW, SUITE 500, WASHINGTON, DC, 20001, US

(21) Appl. No.: 09/550,609

(22) Filed: Apr. 17, 2000

(30) Foreign Application Priority Data
Sep. 28, 1999 (KR) 99-20736

(51) Int. Cl. A47J 27/00; A47J 36/00; A47J 37/01

(52) U.S. Cl. 220/573.1; 99/422

(57) ABSTRACT

A bottom structure for cookware is disclosed. The bottom structure comprises a main plate, an aluminum plate and a cover. The main plate is provided at the peripheral portion of its top surface with a circular groove for holding the lower end of a main body and the peripheral edge of the cover, with the central portion of the main plate being dented. The aluminum plate is disposed in the dented central portion of the main plate. The cover is bent downwardly at its peripheral edge and is positioned on the aluminum plate with its downwardly bent portion inserted into the circular groove of the main body.

### BACKGROUND OF THE INVENTION

1. Field of the Invention

The present invention relates, in general, to cookware and, more particularly, to a bottom structure that can be applied to cookware, such as a kettle, a pot and the like.

2. Description of the Prior Art

The bottom structure for cookware of the present invention may be applied to any cookware. However, in this specification, a kettle will be used as an example for ease of explanation.

As well known to those skilled in the art, a kettle is manufactured by combining a bottom part with a main body. The bottom part of the kettle is of importance because it affects the period of time for heating stuffs contained in the interior of the kettle. Therefore, cookware heated at the bottom, such as a kettle, may have not a single-ply bottom but a multiple-ply bottom, as shown in FIG. 1.

Referring to FIG. 1, the conventional bottom part of a kettle is configured to have a general structure, comprising a main plate 5 provided with a circular groove 5a at the peripheral portion of its top surface, an aluminum plate 7 positioned beneath the center portion of the bottom surface of the main plate 5, and a cover member attached to the main plate 5 while enclosing the aluminum panel 7.

According to the conventional bottom structure of the kettle, the period of time for heating stuffs contained in the interior of the kettle is shortened. However, when the bottom part of the kettle is heated, the components of the bottom part are expanded, thereby causing the cover 6 and the aluminum plate 7 to loosen with regard to the main plate 5. Furthermore, when such heating of the bottom part is repeated, the cover 6 and the aluminum plate 7 are undesirably separated from the main plate 5. More specifically, this phenomenon generally occurs when an empty kettle is heated.

### SUMMARY OF THE INVENTION

Accordingly, the present invention has been made keeping in mind the above problems occurring in the prior art, and an object of the present invention is to provide a bottom structure for cookware, which prevents an aluminum plate positioned in the bottom of the cookware and a cover attached to the main body while enclosing the aluminum plate, from being separated undesirably from the main plate due to repeated heating.

In order to accomplish the above object, the present invention provides a bottom structure for cookware, comprising a main plate provided at the peripheral portion of its top surface with a circular groove for holding the lower end of a main body and the peripheral edge of a cover, a central portion of the main plate being dented, an aluminum plate disposed in the dented central portion of the main plate, and the cover bent downwardly at its peripheral edge and positioned on the aluminum plate with its downwardly bent portion inserted into the circular groove of the main body.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a vertical cross section showing a conventional bottom structure for cookware;

FIG. 2 is a vertical cross section showing a bottom structure for cookware according to the present invention; and

FIG. 3 is a vertical cross section showing a kettle having the bottom structure for cookware of the present invention.

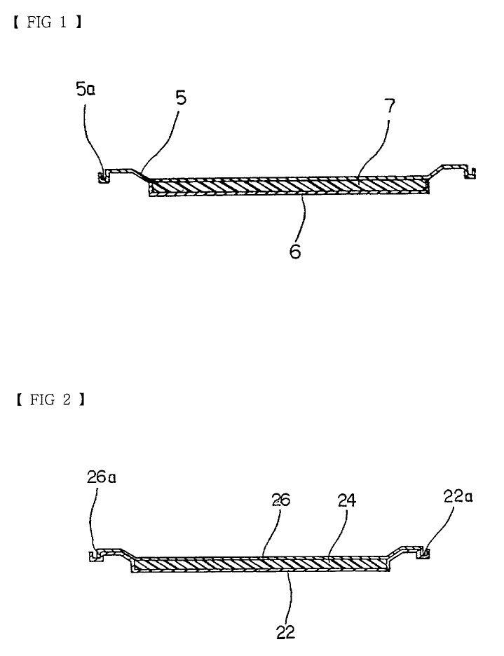

### DESCRIPTION OF THE PREFERRED EMBODIMENTS

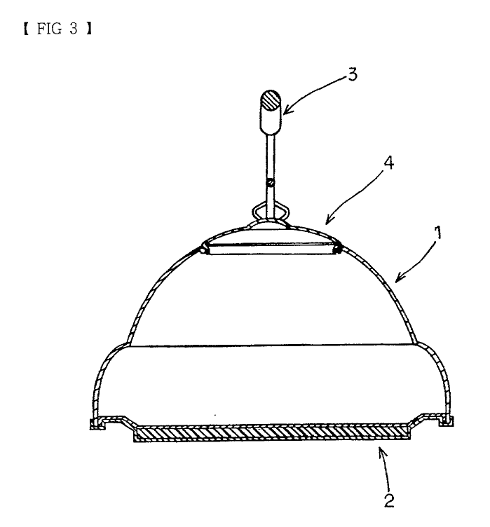

FIG. 2 is a vertical cross section showing a bottom structure for cookware according to the present invention. FIG. 3 is a vertical cross section showing a kettle having the bottom structure for cookware of the present invention.

Referring to the drawings, the bottom 2 of the kettle comprises a main plate 22, an aluminum plate 24 and a cover 26.

The main plate 22 is provided at the peripheral portion of its top surface with a circular groove 22a for holding the lower end of the main body 1 of the kettle and the peripheral edge of the cover 26. The central portion of the main plate 22, which will be heated, is dented by means of a bending process.

The aluminum plate 24 is disposed in the dented central portion of the main plate 22. The aluminum plate 24 serves to shorten the period of time for heating the stuffs contained in the interior of the kettle. The thickness of the aluminum plate 24 may be freely varied according to the capacity of the kettle and the size of the main plate 22.

The cover 26 is bent downwardly at its peripheral edge, thereby forming a downwardly bent portion 26a. The cover 26 is positioned on the aluminum plate 7 with its downwardly bent portion 26a inserted into the circular groove 22a.

Finally, the lower end of the main body 1 is fixedly inserted together with the downwardly bent portion 26ainto the circular groove 22a.

Incidentally, reference numerals 3 and 4 respectively designate a handle and a lid.

In the bottom structure for cookware in accordance with the present invention, since the cover 26 is extended to the circular groove 22a of the main plate 22 and has a downwardly bent peripheral edge 26a, and the downwardly bent edge 26a is fixedly inserted together with the lower end of the main body of the kettle into the circular groove 22a, so that the main plate 22 and the cover 26 are firmly combined with the main body 1 into the kettle.

As described above, the present invention provides a bottom structure for cookware, which prevents an aluminum plate positioned in the bottom of the cookware and a cover attached to the main body while enclosing the aluminum plate, from being separated undesirably from the main plate due to repeated heating.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A bottom structure for cookware, comprising:
a main plate provided at a peripheral portion of its top surface with a circular groove for holding a lower end of a main body and a peripheral edge of a cover, a central portion of said main plate being dented;
an aluminum plate disposed in the dented central portion of said main plate; and
the cover bent downwardly at its peripheral edge and positioned on the aluminum plate with its downwardly bent portion inserted into the circular groove of said main body.
